(19) United States
(12) Patent Application Publication
(10) Pub. No.: US 2023/0244025 A1
(43) Pub. Date: Aug. 3, 2023

(54) MULTI-CORE FIBER, OPTICAL TRANSMISSION SYSTEM, AND OPTICAL TRANSMISSION METHOD

(71) Applicant: Nippon Telegraph and Telephone Corporation, Tokyo (JP)

(72) Inventors: Kenta HIROSE, Musashino-shi, Tokyo (JP); Kohei SAITO, Musashino-shi, Tokyo (JP); Hiroki KAWAHARA, Musashino-shi, Tokyo (JP); Sachio SUDA, Musashino-shi, Tokyo (JP); Takeshi SEKI, Musashino-shi, Tokyo (JP)

(21) Appl. No.: 18/012,107

(22) PCT Filed: Jun. 29, 2020
(86) PCT No.: PCT/JP2020/025444

§ 371 Date: Dec. 21, 2022

(51) Int. Cl. G02B 6/02; G02B 6/293

(52) U.S. Cl. CPC G02B 6/02042; G02B 6/29394

(57) ABSTRACT

A multi-core fiber (23) connects an optical transmitter device (10) and an optical receiver device (30) to each other. The multi-core fiber (23) includes cores each having a wavelength dispersion characteristic different from a wavelength dispersion characteristic of another adjacent core of the cores. In an optical transport system (100), the optical transmitter device (10) and the optical receiver device (30) are connected in series by the plurality of multi-core fibers (23).

### TECHNICAL FIELD

The present invention relates to a multi-core fiber, an optical transport system, and an optical transport method.

### BACKGROUND ART

The transmission capacity achieved by wavelength division multiplexing is expected to reach the limit in the near future. To tackle this scenario, space division multiplexing has been researched. Space division multiplexing can be implemented by means of multi-core fibers formed by integrating a plurality of cores into one optical fiber.

Non-Patent Literature 1 describes an experiment of optical transmission that achieved both dense wavelength division multiplexing in each core of a multi-core fiber and long-distance transmission. Non-Patent Literature 2 explains that one-petabyte unidirectional communication over the distance of 205.6 km was realized by using a multi-core optical fiber having 32 cores. Non-Patent Literature 3 describes cross talk between cores in transmission using multi-core fibers. Cross talk is a phenomenon in which an optical signal passing through a core leaks as noise into another adjacent core.

### CITATION LIST

### Non-Patent Literature

Non-Patent Literature 1: Nippon telegraph and telephone corporation news release. “One Petabit per Second Fiber Transmission over a Record Distance of 200 km”. Mar. 23, 2017. [online]. [Accessed Jun. 23, 2020]. Available from Internet <URL: https://www.ntt.co.jp/news2017/1703/170323a.html>
Non-Patent Literature 2: T. Kobayashi et al., “1-Pb/s (32 SDM/46 WDM/768 Gb/s) C-band Dense SDM Transmission over 205.6-km of Single-mode Heterogeneous Multi-core Fiber using 96-Gbaud PDM-16QAM Channels,” OFC 2017.
Non-Patent Literature 3: Y. Sasaki et al., “Crosstalk-Managed Heterogeneous Single-Mode 32-Core Fibre,” ECOC2016.

### SUMMARY OF THE INVENTION

### Technical Problem

As described in Non-Patent Literature 3, when cross talk occurs between cores of a multi-core fiber, different channels of different cores with the same wavelength adversely affect each other. Hence, the core density of a fiber and the transmission distance are limited.

A main object of the present invention is to reduce cross talk between cores in transmission using a multi-core fiber.

### Means for Solving the Problem

To solve the problem described above, a multi-core fiber according to the present invention has the following characteristics. The present invention is characterized in that a multi-core fiber configured for connecting optical transport devices to each other includes cores each having a wavelength dispersion characteristic different from a wavelength dispersion characteristic of another adjacent core of the cores.

### Effects of the Invention

The present invention can reduce cross talk between cores in transmission using a multi-core fiber.

### BRIEF DESCRIPTION OF DRAWINGS

FIG. 1 is a configuration diagram illustrating an optical transport system according to the embodiment.

FIG. 2 is a hardware configuration diagram of devices of the optical transport system according to the embodiment.

FIG. 3 is a three-dimensional view of a multi-core fiber with four cores according to the embodiment.

FIG. 4 is a cross-sectional view of the multi-core fiber with four cores in FIG. 3 according to the embodiment.

FIG. 5 is a configuration diagram illustrating an optical transport system according to the embodiment.

FIG. 6 is a three-dimensional view of multi-core fibers in FIG. 5 according to the embodiment.

FIG. 7 provides cross-sectional views of the multi-core fibers with four cores in FIG. 6 according to the embodiment.

FIG. 8 provides cross-sectional views of multi-core fibers with four cores according to the embodiment.

FIG. 9 provides cross-sectional views of multi-core fibers with eight cores according to the embodiment.

FIG. 10 provides cross-sectional views of multi-core fibers with sixteen cores according to the embodiment.

### DESCRIPTION OF EMBODIMENTS

Hereinafter, an embodiment of the present disclosure will be described in detail with reference to the drawings.

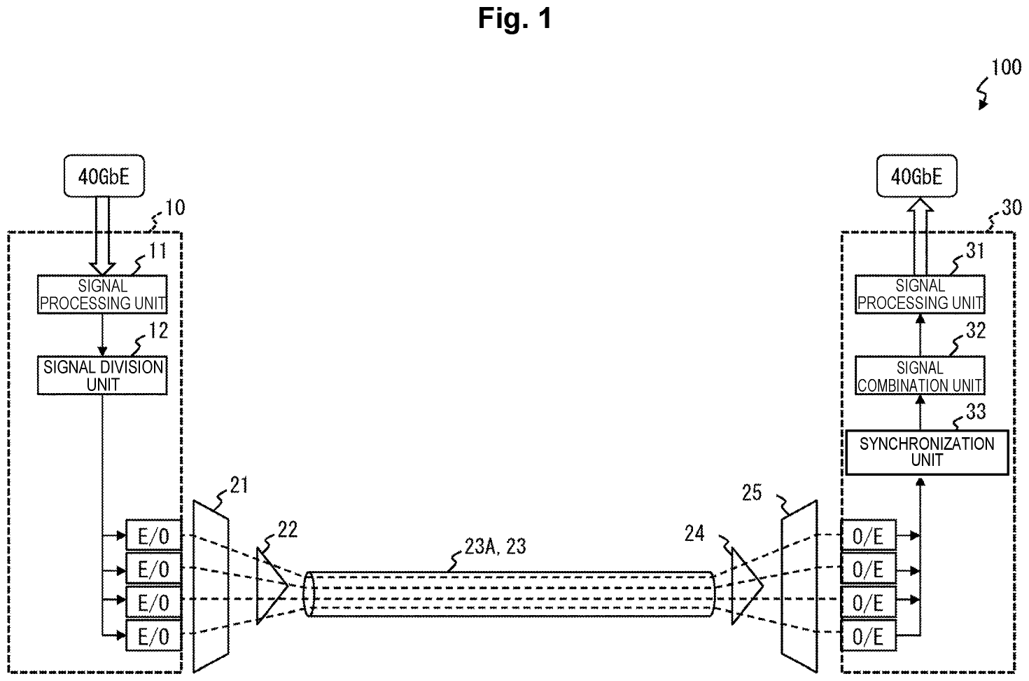

FIG. 1 is a configuration diagram illustrating an optical transport system 100. In the optical transport system 100, packets are inputted from an input-side 40 Gigabit Ethernet (GbE (registered trademark)) line, passed through an optical transmitter device 10, a multi-core fiber 23A, and an optical receiver device 30 in the order presented, and outputted to output-side 40 GbE. The optical transmitter device 10 includes a signal processing unit 11, a signal division unit 12, and four electronic/optical (E/O) signal converters for converting an electrical signal into an optical signal.

The optical receiver device 30 includes a signal processing unit 31, a signal combination unit 32, a synchronization unit 33, and four optical/electronic (O/E) signal converters for converting an optical signal into an electrical signal. In FIG. 1, for ease of description, the optical transmitter device 10 and the optical receiver device 30 are illustrated as different devices. The optical transmitter device 10 and the optical receiver device 30 may be, however, configured as an optical transport device functioning as both the optical transmitter device 10 and the optical receiver device 30.

The signal processing unit 11 of the optical transmitter device 10 communicates to the signal division unit 12 a packet received from the upstream 40 GbE. The signal division unit 12 divides the packet communicated from the signal processing unit 11 into a plurality of sub-packets. Here, the number of cores of the multi-core fiber 23A is four, and thus, one data packet is divided into four sub-packets. The E/O signal converters respectively convert the four sub-packets into optical signals to be passed through different cores (illustrated by four dashed lines). The four optical signals pass through a wavelength combination unit 21, an optical amplifier 22, the multi-core fiber 23A, a wavelength division unit 24, and an optical amplifier 25 in the order presented, and arrive at the O/E signal converters of the optical receiver device 30.

The O/E signal converters convert the four optical signals back into the corresponding sub-packets (electrical signals) and communicate the sub-packets to the synchronization unit 33. The synchronization unit 33 waits until all the four sub-packets arrive and then communicate the four sub-packets to the signal combination unit 32. The signal combination unit 32 combines the four sub-packets to generate one data packet and communicates the resultant data packet to the signal processing unit 31. The signal processing unit 31 outputs the communicated packet to the output-side 40 GbE that is the subsequent transfer destination, in accordance with a transfer table.

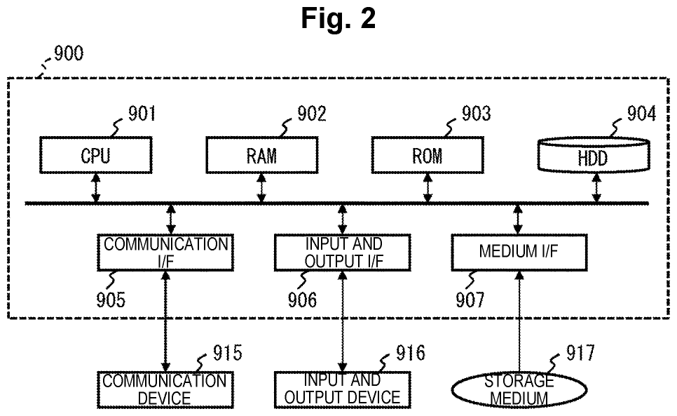

FIG. 2 is a hardware configuration diagram of the devices of the optical transport system 100. The devices (the optical transmitter device 10 and the optical receiver device 30) of the optical transport system 100 are each implemented by a computer 900 including a central processing unit (CPU) 901, a random access memory (RAM) 902, a read only memory (ROM) 903, a hard disk drive (HDD) 904, a communication interface (I/F) 905, an input and output I/F 906, and a medium I/F 907. The communication I/F 905 is connected to a communication device 915 outside. The input and output I/F 906 is connected to an input and output device 916. The medium I/F 907 reads data from a storage medium 917 and writes data to the storage medium 917. The CPU 901 controls the operational units by running a program (also referred to as application, or app, which is short for application) retrieved by the RAM 902. This program can be distributed through communications lines or by means of the storage medium 917 such as a compact disc read-only memory (CD-ROM) storing the program.

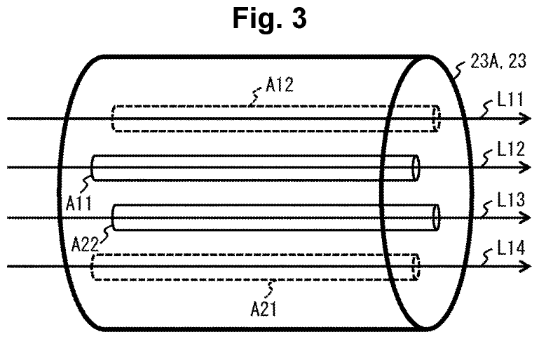

FIG. 3 is a three-dimensional view of the multi-core fiber 23A with four cores. The multi-core fiber 23A includes four cores A11, A12, A21, and A22. An optical signal L11 passes through the core A12; an optical signal L12 passes through the core A11; an optical signal L13 passes through the core A22; an optical signal L14 passes through a core A21.

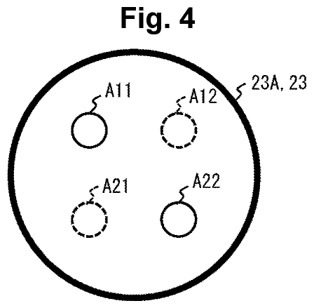

FIG. 4 is a cross-sectional view of the multi-core fiber 23A with four cores in FIG. 3. The cores A11 and A22 indicated by solid lines both have a first wavelength dispersion characteristic. The cores A12 and A21 indicated by dashed lines both have a second wavelength dispersion characteristic. The first wavelength dispersion characteristic and the second wavelength dispersion characteristic are different from each other. This means that, when the optical signals L11 to L14 of the same wavelength are transmitted at the same time, the propagation speed in the cores A11 and A22 of the first wavelength dispersion characteristic is different from the propagation speed in the cores A11 and A22 of the second wavelength dispersion characteristic. The cores may have two kinds (first and second) of wavelength dispersion characteristic as indicated in FIG. 4, or three or more kinds of the wavelength dispersion characteristic.

In the multi-core fiber 23A, the cores are arranged such that adjacent cores are different from each other with respect to the wavelength dispersion characteristic. Specifically, with respect to the wavelength dispersion characteristic, the core A11 is different from the adjacent core A21 positioned within a given distance in the vertical direction and the adjacent core A12 positioned within the given distance in the horizontal direction. As a result, optical signals (for example, the optical signals L11 and L12) pass through adjacent cores at different propagation speeds, resulting in no phase match. As such, cross talk between the cores can be reduced. Although the cores A21 and A22 has the same wavelength dispersion characteristic, the cores A21 and A22 are less likely to cause cross talk. This is because the cores A21 and A22 are apart from each other by the given distance or longer.

[Math. 1]

$${μ}_{X} \approx {κ}_{nm}^{2} \frac{2 {R}_{b} L}{{β}_{c , n} {D}_{nm}} = {κ}_{nm}^{2} \frac{λ {R}_{b} L}{π {n}_{ef , fc , n} {D}_{nm}} \qquad ( Expression 1 )$$

$${μ}_{X} : Average value of inter - core cross talk$$

$${κ}_{nm} : Inter - core mode - coupling constant$$

$${R}_{b} : Fiber bend radius$$

$$L : Fiber length$$

$${β}_{c , n} : Propagation constant$$

$${D}_{nm} : Inter - core distance$$

$$λ : Wavelength$$

$${n}_{eff , c , n} : Effective refractive index$$

Expression 1 is an expression of cross talk between cores. According to Expression 1, by using a multi-core fiber 23 manufactured such that the parameter of “inter-core mode-coupling constant” of the right side is decreased, the “average value of inter-core cross talk” of the left side can be decreased. This expression 1 is specifically explained in the following reference literature. Hayashi, T. and Nakanishi, T. “Multi-Core Optical Fibers for Next-Generation Communications”. January 2018. SEI TECHNICAL REVIEW. No. 192, P. 20-25. [online], [Accessed Jun. 26, 2020]. Available from Internet <URL: https://sei.co.jp/technology/tr/bn192/pdf/192-05.pdf>

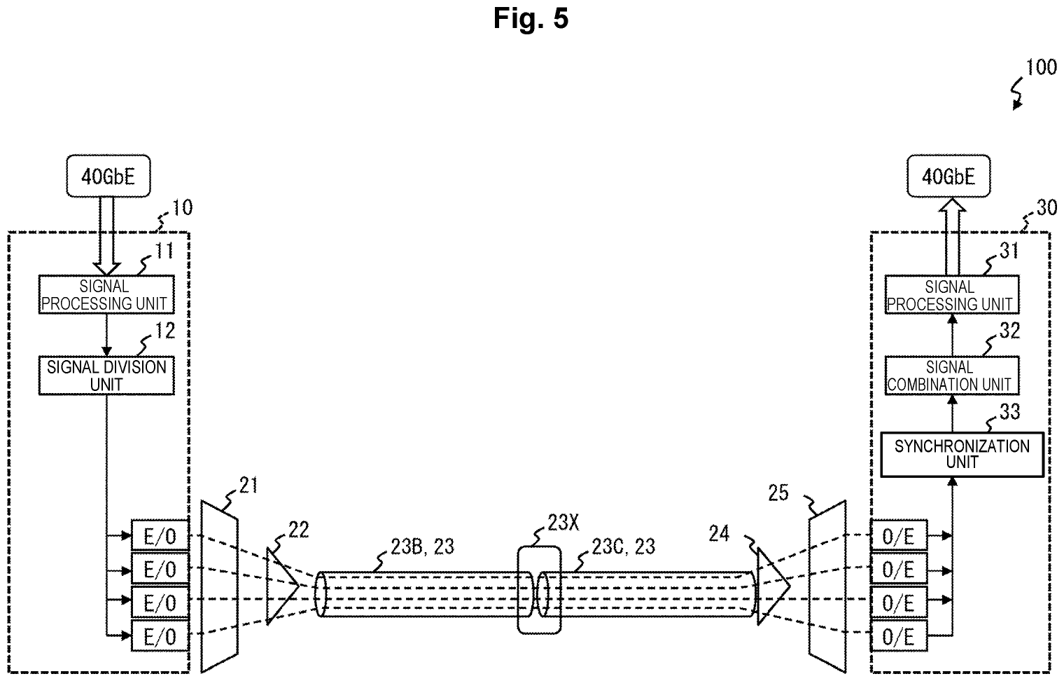

FIG. 5 is a configuration diagram illustrating the optical transport system 100. In the optical transport system 100 in FIG. 1, the optical transmitter device 10 and the optical receiver device 30 are connected to each other by the single multi-core fiber 23A. By contrast, in the optical transport system 100 in FIG. 5, the optical transmitter device 10 and the optical receiver device 30 are connected in series by multi-core fibers 23B and 23C. The multi-core fibers 23B and 23C are connected to each other at a node 23X. The multi-core fiber 23B (first multi-core fiber) is connected to the optical transmitter device 10. The multi-core fiber 23C (second multi-core fiber) is connected to the optical receiver device 30.

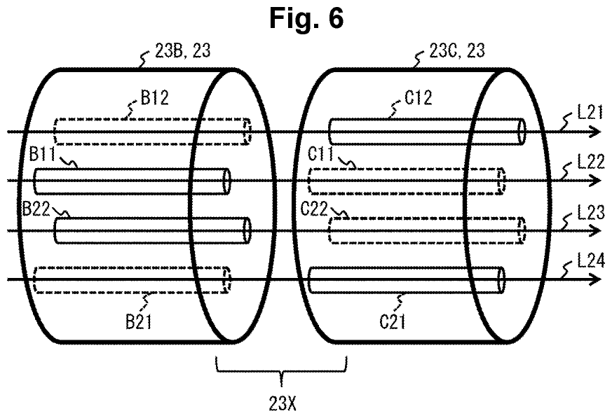

FIG. 6 is a three-dimensional view of the multi-core fibers 23 in FIG. 5. An optical signal L21 is transmitted from the optical transmitter device 10, passed through a core B12 (first core) of the multi-core fiber 23B and a core C12 (second core) of the multi-core fiber 23C, and delivered to the optical receiver device 30. Other optical signals L22 to L24 are passed through the multi-core fibers 23B and 23C in the same manner.

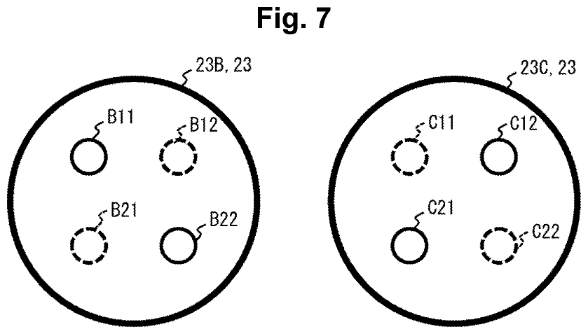

FIG. 7 provides a cross-sectional view of the multi-core fiber 23B with four cores in FIG. 6 and a cross-sectional view of the multi-core fiber 23C with four cores in FIG. 6. In the same manner as the multi-core fiber 23A in FIG. 4, also in the multi-core fibers 23B and 23C, the cores are arranged such that adjacent cores are different from each other with respect to the wavelength dispersion characteristic. With respect to the wavelength dispersion characteristic, the cores B11 to B22 of the multi-core fiber 23B are identical to the cores A11 to B22 of the multi-core fiber 23A illustrated in FIG. 4. Specifically, the cores B11 and B22 indicated by solid lines both have the first wavelength dispersion characteristic. The cores B12 and B21 indicated by dashed lines both have the second wavelength dispersion characteristic. Of the multi-core fiber 23C, cores C12 and C21 indicated by solid lines both have the first wavelength dispersion characteristic. Cores C11 and C22 indicated by dashed lines both have the second wavelength dispersion characteristic. The cores may have two kinds (first and second) of wavelength dispersion characteristic as indicated in FIG. 7, or three or more kinds of the wavelength dispersion characteristic.

The multi-core fibers 23B and 23C are originally the same fiber. The multi-core fibers 23B and 23C are formed by connecting strands of the same fiber in the state in which the strands of the same fiber are rotated at the node 23X. Specifically, the multi-core fiber 23B is rotated 90 degrees to right (in the clockwise direction). As a result, the core B11 is relocated to the core C12; the core B12 is relocated to the core C22; the core B22 is relocated to the core C21; and the core B21 is relocated to the core C11. Accordingly, the cores B11, B22, C12, and C21 indicated by solid lines all have the first wavelength dispersion characteristic. Similarly, the cores B12, B21, C11, and C22 indicated by dashed lines all have the second wavelength dispersion characteristic.

Because the fibers are connected to each other with 90 degree rotation as described above, the optical signals L21 to L24 pass through different fibers of two kinds of wavelength dispersion characteristic from end to end. As such, inter-core cross talk can be reduced in a local manner similarly to FIG. 4, and additionally, variations in the wavelength dispersion characteristic can also be suppressed from end to end in FIG. 7. It is preferable that the transmission distance of the multi-core fiber 23B be the same as the transmission distance of the multi-core fiber 23C.

It is also preferable that the multi-core fiber 23 be formed such that, when the first wavelength dispersion characteristic is a positive wavelength dispersion characteristic, the second wavelength dispersion characteristic is an opposite wavelength dispersion characteristic. As a result, the multi-core fiber 23C serves as a dispersion compensating fiber (DCF) for cancelling wavelength dispersion caused in the multi-core fiber 23B, and thus, the optical receiver device 30 does not need to include the synchronization unit 33.

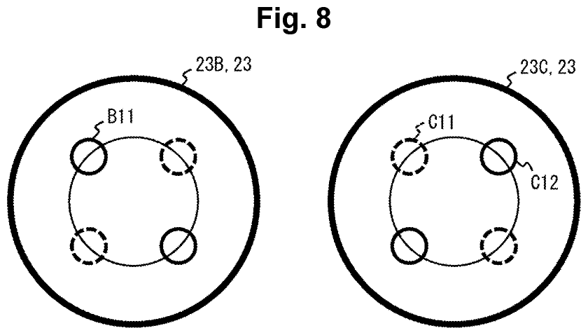

The following describes modifications in which the cores of the multi-core fiber 23B and the cores of the multi-core fiber 23C are arranged regularly (at regular intervals) in concentric circles, with reference to FIGS. 8 to 10. In the multi-core fibers 23B and 23C, the cores are arranged such that “cores next to each other in the circumference of the same circle”, which are adjacent cores, are different from each other with respect to the wavelength dispersion characteristic.

FIG. 8 provides a cross-sectional view of the multi-core fiber 23B with four cores and a cross-sectional view of the multi-core fiber 23C with four cores. In each of the multi-core fibers 23B and 23C, one concentric circle is formed, and four cores are arranged in the concentric circle. This means that the core arrangement in FIG. 8 is the same as the core arrangement in FIG. 4 and the core arrangement in FIG. 7. Adjacent cores in the circumference of the same circle differ from each other such that the cores of the first wavelength dispersion characteristic indicated by solid lines and the cores of the second wavelength dispersion characteristic indicated by dashed lines are alternately arranged. Also in the multi-core fiber 23C, four cores are arranged in the concentric circle. As described with reference to FIG. 7, the core arrangement of the multi-core fiber 23C is made by rotating the multi-core fiber 23B in FIG. 8 to right by 90 degrees. An optical signal passes, for example, from the core B11 to the core C11. The core B11 is relocated to the core C12 by rotation.

The direction and angle of rotation of the multi-core fiber 23B when the multi-core fiber 23B is connected to the multi-core fiber 23C are not limited to the right direction and 90 degrees; the direction and angle of rotation may be the right or left direction and “k/n×180” degrees.

k: any odd number, and k=1 in FIG. 8.

2n: the number of cores in a concentric circle; n is any positive integer, and n=2 in FIG. 8.

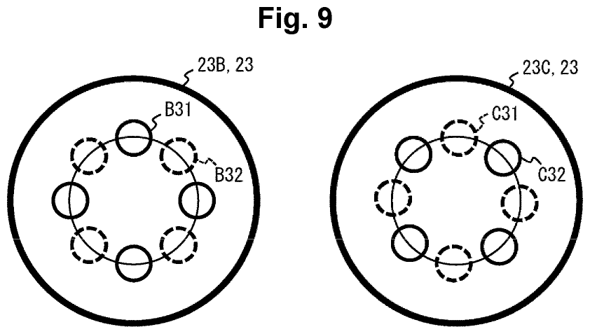

FIG. 9 provides a cross-sectional view of the multi-core fiber 23B with eight cores and a cross-sectional view of the multi-core fiber 23C with eight cores. In each of the multi-core fibers 23B and 23C, one concentric circle is formed, and eight cores are arranged in the concentric circle. In the core arrangement of these multi-core fibers, adjacent cores in the circumference of the same circle differ from each other such that the cores of the first wavelength dispersion characteristic indicated by solid lines and the cores of the second wavelength dispersion characteristic indicated by dashed lines are alternately arranged. The core arrangement of the multi-core fiber 23C is made by rotating the multi-core fiber 23B to right by 45 degrees (given by “k/n×180”, where n=4, and k=1). A first optical signal passes from a core B31 to a core C31. A second optical signal passes from a core B32 to a core C32. The core B31 is relocated to the core C32 by rotation.

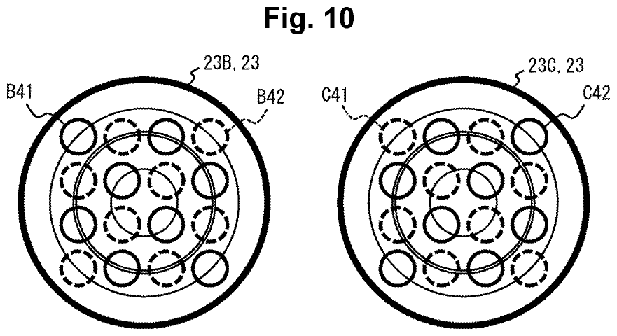

FIG. 10 provides a cross-sectional view of the multi-core fiber 23B with sixteen cores and a cross-sectional view of the multi-core fiber 23C with sixteen cores. In each of the multi-core fibers 23B and 23C, three concentric circles are formed. The three concentric circles are referred to as a first concentric circle (single line in the drawing), a second concentric circle (double line in the drawing), and a third concentric circle (single line in the drawing); the radius increases in the order presented. Four cores are arranged in each of the first and third concentric circles (n=2). Eight cores are arranged in the second concentric circle. This arrangement is made by overlaying two concentric circles with four cores (n=2). As such, the core arrangement of the multi-core fibers 23B and 23C is constituted by only concentric circles having the arrangement of n=2. In the core arrangement of these multi-core fibers, adjacent cores in the circumference of the same circle differ from each other such that the cores of the first wavelength dispersion characteristic indicated by solid lines and the cores of the second wavelength dispersion characteristic indicated by dashed lines are alternately arranged. The core arrangement of the multi-core fiber 23C is made by rotating the multi-core fiber 23B to right by 90 degrees (given by “k/n×180”, where n=2, and k=1). The first optical signal passes from a core B41 to a core C41. The second optical signal passes from a core B42 to a core C42. The core B41 is relocated to the core C42 by rotation.

[Effects]

The present invention is characterized in that the multi-core fiber 23 configured for connecting the optical transmitter device 10 and the optical receiver device 30 to each other includes cores each having a wavelength dispersion characteristic different from a wavelength dispersion characteristic of another adjacent core of the cores.

With this configuration, it is possible to reduce cross talk between cores in transmission using the multi-core fiber 23.

The present invention is characterized in that the optical transport system 100 includes the optical transmitter device 10 and the optical receiver device 30 connected in series by the plurality of multi-core fibers 23, in which each multi-core fiber 23 includes cores each having a wavelength dispersion characteristic different from a wavelength dispersion characteristic of another adjacent core of the cores, and in which, when an optical signal passes through the first core of the first multi-core fiber 23 and the second core of the second multi-core fiber 23, the wavelength dispersion characteristic of the first core is different from the wavelength dispersion characteristic of the second core.

This configuration can suppress variations in the wavelength dispersion characteristic between cores.

The present invention is characterized in that the cores of each multi-core fiber 23 are regularly arranged in a concentric circle, and the second multi-core fiber 23 is connected to the first multi-core fiber 23 in the state in which the second multi-core fiber 23 having the same core arrangement as the first multi-core fiber 23 is rotated relative to the first multi-core fiber 23.

With this configuration, wavelength dispersion can be reduced with the use of only one kind of fiber.

The present invention is characterized in that the wavelength dispersion characteristic of the second core is opposite to the wavelength dispersion characteristic of the first core.

With this configuration, wavelength dispersion is reduced, and as a result, it is possible to ease limitations on the core density of a fiber and the transmission distance.

### REFERENCE SIGNS LIST

10 Optical transmitter device (optical transport device, first optical transport device)
11 Signal processing unit
12 Signal division unit
21 Wavelength combination unit
22 Optical amplifier
23, 23A Multi-core fiber
23B Multi-core fiber (first multi-core fiber)
23C Multi-core fiber (second multi-core fiber)
23X Node
24 Wavelength division unit
25 Optical amplifier
30 Optical receiver device (optical transport device, second optical transport device)
31 Signal processing unit
32 Signal combination unit
33 Synchronization unit
100 Optical transport system

1. A multi-core fiber configured for connecting optical transport devices to each other, the multi-core fiber comprising:
cores each having a wavelength dispersion characteristic different from a wavelength dispersion characteristic of another adjacent core of the cores.

2. An optical transport system including optical transport devices connected in series by a plurality of multi-core fibers, wherein
each multi-core fiber includes cores each having a wavelength dispersion characteristic different from a wavelength dispersion characteristic of another adjacent core of the cores; and when an optical signal passes through a first core of a first multi-core fiber of the plurality of multi-core fibers and a second core of a second multi-core fiber of the plurality of multi-core fibers, a wavelength dispersion characteristic of the first core is different from a wavelength dispersion characteristic of the second core.

3. The optical transport system according to claim 2, wherein
the cores of each multi-core fiber are regularly arranged in a concentric circle, and
the second multi-core fiber is connected to the first multi-core fiber in a state in which the second multi-core fiber having the same core arrangement as the first multi-core fiber is rotated relative to the first multi-core fiber.

4. The optical transport system according to claim 2, wherein
the wavelength dispersion characteristic of the second core is opposite to the wavelength dispersion characteristic of the first core.

5. An optical transport method implemented by an optical transport system including optical transport devices connected in series by a plurality of multi-core fibers, wherein
each multi-core fiber includes cores each having a wavelength dispersion characteristic different from a wavelength dispersion characteristic of another adjacent core of the cores; and when an optical signal passes through a first core of a first multi-core fiber of the plurality of multi-core fibers and a second core of a second multi-core fiber of the plurality of multi-core fibers, a wavelength dispersion characteristic of the first core is different from a wavelength dispersion characteristic of the second core,
the optical transport method comprising:
transmitting an optical signal to each core of the first multi-core fiber by using a first optical transport device; and
receiving an optical signal from each core of the second multi-core fiber by using a second optical transport device.
